(19) United States
(12) Patent Application Publication
(10) Pub. No.: US 2025/0002194 A1
(43) Pub. Date: Jan. 2, 2025

(54) SEALING DEVICE, SEALING STATION AND METHOD FOR PRODUCING SUCH A SEALING DEVICE

(71) Applicant: Ampack GmbH, Königsbrunn (DE)

(72) Inventors: Jürgen Haak, Sonnenbühl (DE); Ilona Klein, Neufahrn bei Freising (DE); Alexander Gaab, Aurach (DE); Markus Zimmermann, Landsberg am Lech (DE); Korbinian Tomschi, Zahling (DE); Alois Sturm, Friedberg (DE)

(21) Appl. No.: 18/688,478

(22) PCT Filed: Sep. 23, 2022
(86) PCT No.: PCT/EP2022/076472

§ 371 Date: Mar. 1, 2024

(30) Foreign Application Priority Data
Sep. 24, 2021 (DE) 10 2021 124 797.7

(51) Int. Cl. B65B 51/14; B65B 51/10

(52) U.S. Cl. CPC B65B 51/14; B65B 2051/105

(57) ABSTRACT

A sealing device, in particular a sealing head, for a sealing of a container (12a; 12e) includes at least one sealing tool (34a; 34b; 34c; 34d; 34e; 34f; 34g; 34h; 34i), which forms a ring-shaped sealing zone for physical contact with the container (12a; 12e), and includes at least one ceramic heating unit (36a; 36b; 36c; 36d; 36e; 36f; 36g; 36h; 36i) for heating the sealing zone which generates a sealing. The ceramic heating unit (36a; 36b; 36c; 36d; 36e; 36f; 36g; 36h; 36i) includes a heating conductor, which is in a heating region of the ceramic heating unit (36a; 36b; 36c; 36d; 36e; 36f; 36g; 36h; 36i) surrounded at least substantially completely by a thermally conductive ceramic base body (40a, 42a; 40b, 42b; 40c, 42c; 40d, 42d; 40e, 42e; 40f, 42f; 40g, 42g; 40h; 40i, 46i) of the ceramic heating unit (36a; 36b; 36c; 36d; 36e; 36f; 36g; 36h; 36i).

### CROSS-REFERENCE TO RELATED APPLICATIONS

This patent application claims the benefit of and incorporates herein by reference the German patent application DE 10 2021 124 797.7, filed on Sep. 24, 2021, and the international patent application PCT/EP2022/076472, filed on Sep. 23, 2022.

### BACKGROUND

In EP 3 515 693 B1 a sealing device for a sealing of a container has already been proposed. This sealing device comprises at least one sealing tool, which forms a ring-shaped sealing zone for a physical contact with the container, and at least one ceramic heating unit for a heating of the sealing zone which generates a sealing.

Furthermore, from DE 10 2016 218 218 A1 a sealing device for a sealing of a container is already known, wherein the already-known sealing device comprises at least one sealing tool, which forms a ring-shaped sealing zone for a physical contact with the container, and at least one ceramic heating unit for a heating of the sealing zone which generates a sealing.

Moreover, also from DE 10 2009 046 469 A1, U.S. Pat. No. 2,649,392 A, DE 10 62 004 B and WO 2016/055599 A1 sealing devices for a sealing of a container are already known.

### SUMMARY

The invention is based on a sealing device, in particular a sealing head, for a sealing of a container, with at least one sealing tool, which forms a ring-shaped sealing zone for a physical contact with the container, and with at least one ceramic heating unit for a heating of the sealing zone which generates a sealing.

It is proposed that the ceramic heating unit comprises a heating conductor, which is in a heating region of the ceramic heating unit surrounded at least substantially completely by a thermally conductive ceramic base body of the heating unit. The container in particular comprises a receiving unit, which is configured to receive a product for packaging, in particular a container cover. The product for packaging may comprise, for example, a liquid, a pasty mass, a bulk product and/or an individually packaged product. The product for packaging is, for example, a food product, a pharmaceutical product, a consumer good, or the like. The receiving unit may in particular be embodied as a cup, as a bottle, as a collapsible tube, as a shell, as a box or something like that. The receiving unit is preferably sealed with the container cover. Preferentially, the container cover is configured, by the sealing, to close the receiving unit in a watertight and/or airtight fashion. In particular depending on the product for packaging, the receiving unit and/or the container cover may be made of metal, glass, ceramic, wood, paper, plastic and/or of a composite material. The receiving unit and the container cover may be made of the same material or of different materials. Preferably the container cover is realized foil-shaped or plate-shaped, in particular as a sealing lid.

The sealing device is configured to connect the container cover, which is—in particular loosely—adjacent to the receiving unit, by substance-to-substance bond with the receiving unit by force and/or energy transmission, thus sealing the container. The sealing device in particular comprises at least one force and/or energy transmission element for a force and/or energy transmission to the container. In particular, the sealing device comprises at least the ceramic heating unit as a force and/or energy transmission element for a transfer of heat to the container. For example, the sealing device comprises as a force and/or energy transmission element, in particular in addition to the ceramic heating unit, at least one pressing tool for pressing the container cover onto the receiving unit. Preferably the sealing device comprises at least one sealing holder, which the ceramic heating unit is arranged on. The sealing tool is configured for a direct contact with the container. The sealing tool is in particular arranged on the sealing holder and/or on the force and/or energy transmission element. The sealing tool may be realized as an individual component or in a one-part implementation with the ceramic heating unit or with the sealing holder. “In a one-part implementation” is in particular to mean formed in one piece. Preferably this one piece is produced from a single blank, from a mass and/or from a cast, particularly preferentially in an injection-molding process, in particular a one-component or multi-component injection-molding process. Preferably the sealing device comprises at least one drive element for a movement of the sealing tool along a sealing direction, in particular towards the container. The drive element is in particular configured, before the sealing, to bring the sealing tool into physical contact with the container, and in particular to remove the sealing tool from the container after the sealing. Preferentially the drive element is embodied as a linear drive, as a stepper motor or as a servo drive. The ring-shaped sealing zone in particular has a material recess in a plane perpendicular to the sealing direction. In the plane perpendicular to the sealing direction, the ring-shaped sealing zone has an outer circumference and an inner circumference, which in particular delimits the material recess. Preferably the outer circumference and the inner circumference are arranged concentrically. Alternatively, respective geometric centers of the outer circumference and of the inner circumference are arranged offset from each other. The outer circumference and the inner circumference preferably in each case form a closed line or a closed line contour, which may in particular be realized in any shape, depending on a respective application. For example, the outer circumference and/or the inner circumference, each individually, form a circle, an oval, a rectangle, a polygon, or a different shape, which is in particular adapted to a sealing surface of the container. In particular, the outer circumference and the inner circumference may have the same shape, except for a scaling factor, or may have different shapes. Preferably an average material thickness of the sealing zone between the outer circumference and the inner circumference, perpendicular to the sealing direction, is smaller than a maximum aperture dimension of the material recess in the plane perpendicular to the sealing direction, preferentially smaller than half this maximum aperture dimension, optionally smaller than a quarter of this maximum aperture dimension.

The ceramic heating unit is in particular configured, in particular before a contact of the sealing tool with the container, to heat the sealing tool to a sealing temperature and optionally to maintain the sealing tool at the sealing temperature during the sealing. The ceramic base body is preferably made of an electrically insulating material and/or is coated with an electrically insulating sheathing. Preferably the ceramic base body and the heating conductor are made of the same ceramic basic material, wherein the heating conductor is in particular doped in order to increase an electrical conductivity of the heating conductor relative to the ceramic base body. Alternatively, the heating conductor is made of metal. The heating conductor is in particular configured for heating the ceramic base body, wherein the ceramic base body conveys heat to the sealing tool. The ceramic base body preferably has a thermal conductivity of more than 20 W/mK, preferentially of more than 35 W/mK, optionally a thermal conductivity of more than 100 W/mK. Except for a contact area or connection wires for a connection of a supply line and an outgoing line of electrical current, the heating conductor is preferably surrounded by the ceramic base body completely. The ceramic base body is in its interior preferably realized at least substantially homogeneously, in particular without layers. In particular, manufacturing-related layers within the ceramic base body, caused for example by layer-wise application of a ceramic raw mass, differ in chemical and/or physical properties by less than 25%, preferentially by less than 15%, especially preferentially by less than 5% from an average value of the respective property of the base body. In particular, the ceramic base body has, starting from the heating conductor, in any direction perpendicular to a contour of the heating conductor, the same thermal conductivity, in particular at least in the range of the fluctuations mentioned above. In particular, the ceramic base body has an at least substantially quasi-isotropic thermal conductivity, in particular at least in the range of the fluctuation mentioned above. Due to diffusion processes, in regions of the ceramic base body which are arranged nearer the heating conductor, chemical and/or physical characteristics may differ from regions of the ceramic base body which are arranged farther away from the heating conductor.

The implementation according to the invention advantageously allows reliable safeguarding of the heating conductor against damaging. In particular, even if the ceramic base body is damaged, for example if material has splintered off, continued reliable usage of the ceramic heating unit is advantageously possible. In particular, a risk of damaging of the heating conductor can be kept advantageously low.

Furthermore, it is proposed that the ceramic heating unit comprises at least one further ceramic base body which is realized separately from the ceramic base body, wherein, in a plane that is perpendicular to a sealing direction, in particular the aforementioned sealing direction, the ceramic base body and the further ceramic base body are arranged at least substantially at equal distances from a geometric center of the ceramic heating unit, in particular of the ring-shaped sealing zone. The further ceramic base body preferably surrounds a further heating conductor, which is realized separately from the heating conductor. Alternatively, the ceramic base body and the further ceramic base body are arranged at the same heating conductor. The ceramic base body and the further ceramic base body may, in particular at a sealing temperature, be in physical contact to each other and/or may, in particular at an ambient temperature, be arranged spaced apart from each other. In particular, the ceramic base body, the further ceramic base body and optionally further ceramic base bodies of the ceramic heating unit segment-wise copy a shape of the sealing zone, in particular parallel to the inner circumference and/or to the outer circumference of the sealing zone. In particular, a surface of the ceramic heating unit, which faces towards the sealing tool and/or forms the sealing tool and which is distributed over the ceramic base bodies, has at least substantially the same surface area as the sealing zone, in particular the same surface area except for 20%, preferentially except for 10%, especially preferentially except for 5%. Preferably the ceramic base bodies are realized at least substantially identical in terms of construction, in particular except for a manufacturing tolerance, and are in particular arranged in a rotationally symmetrical or rotary-symmetrical manner. Due to the implementation according to the invention, it is advantageously possible to do without replacement of the entire ceramic heating unit if there is functional failure and/or deficient sealing due to one of the ceramic base bodies with the associated heating conductor. In particular, maintenance costs of the sealing device may be kept at an advantageously low level.

It is further proposed that the ceramic heating unit comprises at least one additional ceramic base body which is realized separately from the ceramic base body, wherein the ceramic base body and the additional ceramic base body are arranged on different closed paths around a geometric center of the ceramic heating unit, in particular of the ring-shaped sealing zone. The different paths are preferably realized concentrically with respect to the geometric center. In particular, viewed from the geometric center, the ceramic base body and the further ceramic base body are arranged one behind the other one. The ceramic base body and the further ceramic base body may be arranged on their respective path in corresponding positions, in particular such that the ceramic base body covers the further ceramic base body when viewed from the geometric center, or may be arranged offset from each other along their respective path, in particular such that the ceramic base body at most partially covers the further ceramic base body. The additional ceramic base body preferably surrounds an additional heating conductor, which is realized separately from the heating conductor. Alternatively, the ceramic base body and the additional ceramic base body are arranged at the same heating conductor. The ceramic base body and the additional ceramic base body may, in particular at a sealing temperature, be in physical contact to each other, and/or may, in particular at an ambient temperature, be arranged spaced apart from each other. In particular, the ceramic base body, the additional ceramic base body and optionally further ceramic base bodies of the ceramic heating unit segment-wise copy the shape of the sealing zone, in particular in a direction perpendicular to the inner circumference and/or the outer circumference of the sealing zone. For example, the ceramic heating unit comprises a path with a diameter of 75 mm, on which the ceramic base body, and optionally the at least one further ceramic base body, is arranged, in particular for heating a 75-mm sealing zone for a 75-mm container. For example, the ceramic heating unit comprises a path with a diameter of 95 mm, on which the additional ceramic base body and optionally further additional ceramic heating bodies are arranged, in particular for heating a 95-mm sealing zone for a 95-mm container. The implementation according to the invention allows using the ceramic heating unit for an advantageously large number of container sizes.

Moreover, it is proposed that the sealing device comprises a control or regulation unit for a separate controlling or regulation of a temperature of the different ceramic base bodies. A “control or regulation unit” is in particular to mean a unit that includes at least one control electronics unit. A “control electronics unit” is in particular to mean a unit with a processor unit and with a memory unit as well as with an operation program stored in the memory unit. The control or regulation unit may be configured to adjust the temperature of each ceramic base body with one of the heating conductors individually or to adjust the temperature of groups of ceramic base bodies individually. A group of ceramic base bodies comprises, for example, all ceramic base bodies which are arranged on the same path around the geometric center of the ceramic heating unit, and in particular excludes all ceramic base bodies which are arranged on different paths around the geometric center of the ceramic heating unit. The implementation according to the invention advantageously allows adapting the sealing zone variably to a container geometry of the container by different actuation of the heating conductors on the different paths. In particular, an energy used for sealing can be kept advantageously low as heating conductors which are not required for a certain container will not be actuated. Furthermore, it is possible in an interaction with temperature sensors in/at the ceramic base bodies to subsequently adjust a setting or a regulation of the ceramic heating unit in an advantageously precise and selective manner. In particular, in the case of deficient sealing quality of one of the ceramic base bodies, an adaption of an actuation of the entire ceramic heating unit can be dispensed with.

Beyond this it is proposed that at least one electrical connection of the ceramic heating unit for the heating conductor extends transversely, in particular at least substantially perpendicularly, to a sealing direction. The term “substantially perpendicularly” is here in particular intended to define an orientation of a direction relative to a reference direction, wherein the direction and the reference direction, in particular viewed in a projection plane, include an angle of 90° and the angle has a maximum deviation of in particular less than 8°, advantageously less than 5° and especially advantageously less than 2°. Particularly preferably all electrical connections of the ceramic heating unit, in particular for the heating conductors and in particular for sensors arranged in/at the ceramic heating unit, are arranged transversely to the sealing direction and are in particular oriented towards the middle axis of the sealing device. Preferably the electrical connection is arranged on a side of the ceramic base body that is arranged facing away from the sealing tool. The side of the ceramic base body which the electrical connection is arranged on is preferably arranged facing away from the middle axis, alternatively facing towards the middle axis. Alternatively, the electrical connection extends at least substantially parallel to the sealing direction. “Substantially parallel” is here in particular to mean an orientation of a direction relative to a reference direction, in particular in a plane, wherein the direction has a deviation from the reference direction that is in particular smaller than 8°, advantageously smaller than 5° and especially advantageously smaller than 2°. Due to the implementation according to the invention, it is advantageously possible to bring the electrical connections together centrally. In particular, an advantageously large construction space of the sealing device can be kept free of electrical connections. Furthermore, advantageously strain relief of the electrical connections is achievable.

It is also proposed that the at least one ceramic base body at least partially forms the sealing tool with the sealing zone for a direct contact with the container. A side of the ceramic base body which forms the sealing tool may be realized smooth or having a structure, for example fluted, undulated, provided with nubs, provided with a lattice, or the like. The ceramic heating unit is arranged on the sealing holder, in particular on a side of the sealing holder facing away from the drive element. The implementation according to the invention advantageously allows providing a sealing device with an advantageously low number of individual parts. In particular, a thermal resistance, in particular due to contact resistances, from the heating conductor to the container can be kept advantageously low. In particular, a heat capacity of a segment of the sealing zone can be kept advantageously low. In particular, an anormal temperature drop of the ceramic base body, for example due to dirt or liquid on the container, can be detected advantageously quickly.

Furthermore, it is proposed that the sealing tool is realized as an attachment which is arranged, in particular reversibly, at the ceramic base body. “Arranged reversibly” is in particular to mean fixed in such a way that it is detachable without destruction. In particular, the sealing tool can be fixed on and detached from the ceramic base body several times without wear-related functionality reduction of the sealing tool and/or of the ceramic base body. The attachment is preferably made of metal, for example of stainless steel, in particular of heat-resistant steel. The attachment is preferably fastened, in particular screwed, alternatively latched in to the sealing holder. Preferably the sealing device comprises at least one holder for fixing the ceramic heating unit at the sealing holder, in particular for enclosing, optionally clamping, the ceramic sealing unit between the sealing holder and the holder in a form-fitting manner. In an implementation of the sealing tool as an attachment, the sealing tool may be realized in a one-part implementation with the holder or may be realized separately from the holder. The implementation according to the invention allows advantageously flexible and simple adaption of a shape and/or size of the sealing zone, in particular without exchanging or modifying the ceramic heating unit.

Moreover it is proposed that the sealing device comprises a centering unit for a securing of the container during a sealing process, and comprises a sealing holder, in particular the aforementioned sealing holder, for an accommodation of the ceramic heating unit, the ceramic heating unit being arranged in a form-fitting manner between the centering unit and the sealing holder. The centering unit is in particular arranged in the material recess of the sealing zone. The centering unit is preferably configured for securing a relative arrangement of the container cover with respect to the receiving unit. The centering unit has, for example, an outward-domed abutment surface, which is configured for a direct contact with the container, in particular the container cover. Preferably the abutment surface projects beyond the sealing zone along the sealing direction, in particular such that the centering unit, before a contact of the sealing zone with the container cover, pushes the container cover towards the receiving unit, in particular bends a central region of the container cover into the receiving unit. In particular, the centering unit is realized in a one-part implementation with the holder for the ceramic heating unit and/or with the sealing tool. Alternatively, the centering unit is realized separately from the holder for the ceramic heating unit and/or from the sealing tool. The implementation according to the invention allows providing a sealing device with an advantageously low number of individual components. Beyond this, a risk of a container cover jamming within the material recess of the sealing zone can be kept advantageously low.

It is also proposed that the sealing device comprises a sealing holder, in particular the aforementioned sealing holder, for an accommodation of the ceramic heating unit, wherein the sealing holder forms the sealing tool with the sealing zone. In particular, the ceramic heating unit is embedded in a depression of the sealing holder. The depression preferably extends from a side of the sealing holder that faces away from the sealing tool into the sealing holder. The sealing holder is preferably made of metal, for example of stainless steel, in particular of heat-resistant steel. In particular, the sealing holder is formed in a plate shape or disk shape. Preferably a material thickness of the sealing holder parallel to the sealing direction from a support surface of the ceramic heating unit in the depression as far as the sealing zone is smaller than a maximum extent of the ceramic base body in this direction. Preferably the ceramic base body is arranged completely in the depression and in particular does not protrude from the sealing holder. A side of the sealing holder which forms the sealing tool may be realized smooth or having a structure, for example fluted, undulated, provided with nubs, provided with a lattice, or the like. The implementation according to the invention allows keeping a risk of the ceramic heating unit being damaged advantageously low.

Furthermore, it is proposed that the at least one ceramic base body is made of silicon nitride or aluminum nitride. Preferably all ceramic base bodies, in particular at least all ceramic base bodies on the same closed path, are made of the same material. Optionally ceramic base bodies on different ones of the paths around the geometric center of the sealing zone are made of different materials. Due to the implementation according to the invention, the ceramic heating unit has at the same time an advantageously high thermal conductivity, an advantageously low heat capacity and/or an advantageously high hardness.

Preferably the sealing device comprises at least one test unit, which is at least partially integrated in a sealing unit of the sealing device, for a monitoring of a sealing quality of the container sealed by the sealing unit, the test unit comprising at least one temperature sensor for a detection of a sealing temperature. Preferentially the temperature sensor is arranged in a sensor material recess of the ceramic base body of the ceramic heating unit of the sealing unit, and/or the temperature sensor is arranged in a sensor material recess of a sealing tool of the sealing unit, wherein the sensor material recess of the sealing tool is arranged in a proximity of the ceramic heating unit. Due to the implementation of the sealing device according to the invention, it is advantageously possible to collect sensor data for a determination of the sealing quality already during the sealing and/or immediately after the sealing. A separate check of the sealing quality, in particular an independent container checking station, downstream of the sealing, can be dispensed with. In this way, in particular a total length and a throughput time of a filling and/or production installation for filling the containers with the product for packaging, which uses the sealing device, can be kept advantageously short. It is advantageously possible to detect the sealing temperature individually for each of the containers which are to be sealed. In particular, advantageously a change in the sealing temperature can be monitored during the sealing. In particular, the sealing temperature can be evaluated for a determination of the sealing quality. Advantageously, it is for example possible to distinguish, on the basis of different temperature changes, between a bent container cover, a double-layer container cover, a container cover displaced relative to the receiving unit, a contamination located between the container and the container cover, like for example a fluid, a food product residue or other contaminations, or the like.

Preferably, in at least one implementation of the sealing device according to the invention, the temperature sensor is arranged in a sensor material recess of the sealing tool which is arranged in a proximity of the ceramic base body of the ceramic heating unit. Preferably, when arranged in a proximity of the ceramic base body of the ceramic heating unit, the sensor material recess is arranged outside the ceramic base body of the ceramic heating unit, preferably directly in the sealing tool. By a “proximity” is in particular a region of an element to be understood which has, in particular relative to a further element, in particular relative to an outer surface of the further element facing towards the element, a maximum distance in particular of less than 25 mm, preferably of less than 10 mm and particularly preferably of less than 8 mm. Preferentially the temperature sensor has, relative to the ceramic heating unit, in particular relative to the base body, a maximum distance in particular of less than 25 mm, preferably of less than 10 mm and particularly preferably of less than 8 mm. Preferentially the temperature sensor is arranged in the sensor material recess of the sealing tool in such a way that the temperature sensor, in particular a temperature detection region of the temperature sensor, like for example a temperature sensor tip or the like, is arranged spaced apart from a sealing surface, in particular an from outer sealing surface, of the sealing tool or from a contact plane of the sealing unit, at an—in particular maximum—distance of in particular less than 10 mm, preferably of less than 5 mm and particularly preferably of less than 2 mm. Preferentially the ring-shaped sealing zone forms the sealing surface of the sealing tool. Preferably, in a state when arranged in the sensor material recess of the sealing tool, the temperature sensor has, along a direction that runs at least substantially perpendicularly to the sealing surface of the sealing tool, an—in particular maximum—distance with a value between 0.1 mm and 5 mm. It is conceivable that in at least one implementation of the sealing device according to the invention, the temperature sensor is arranged in the sensor material recess of the sealing tool and in the sensor material recess of the base body of the heating unit. The temperature sensor may be arranged partly in the base body of the heating unit and partly in the sealing tool. The temperature sensor may extend completely through the base body into the sealing tool. It is also conceivable that the temperature sensor is arranged completely outside the base body. It is further conceivable that the test unit comprises two separate temperature sensors, wherein one of the temperature sensors is arranged in or at the sealing tool and the other one of the temperature sensors is arranged in or at the base body, in particular so as to enable an advantageous target-performance comparison of a temperature, in particular a comparison of a desired target temperature at the base body of the heating unit to a real temperature actually prevailing at the sealing tool. Advantageously, providing two separate temperature sensors, with one of the temperature sensors being arranged at the sealing tool and another one of the temperature sensors being arranged at the base body of the heating unit, preferably enables redundant temperature detection.

The temperature sensor is preferably embodied as a contact sensor, particularly preferentially as a resistance thermometer, alternatively as an expansion thermometer, or as a thermocouple. Preferably the temperature sensor is arranged at the energy and/or force transmission element and/or at the sealing tool, or it is embedded in the energy and/or force transmission element and/or in the sealing tool. Alternatively, the temperature sensor is arranged at or in the sealing holder. Alternatively, the temperature sensor is configured for a contactless measuring of the sealing temperature and is embodied, for example, as a pyrometer or as a thermographic camera. Preferably the temperature sensor is configured to detect as a sealing temperature a temperature of the energy and/or force transmission element, of the sealing tool and/or of the container. Preferentially the temperature sensor is configured to detect a temperature drop of the energy and/or force transmission element and/or of the sealing tool when in contact with the container. Alternatively, the temperature sensor is configured to detect a temperature rise of the container upon contact with the energy and/or force transmission element and/or with the sealing tool.

Beyond this it is conceivable, in particular in at least one implementation of the sealing device according to the invention, that the test unit comprises at least two, in particular several, temperature sensors and a computing unit, in particular the aforementioned computing unit, for an evaluation of the test parameter captured by the temperature sensors, wherein the computing unit is configured to determine the sealing quality depending on a comparison of two values of the test parameter captured in at least two different measuring points which are assigned to the same container. It is conceivable that in an alternative implementation, for solving the task of enabling a structurally simple and reliable determination of a sealing quality, the sealing device is realized independently from the arrangement of the temperature sensor in a sensor material recess. Preferably in the alternative implementation, in particular in the implementation realized independently from the arrangement of the temperature sensor in a sensor material recess, the sealing device comprises at least one sealing unit for a force and/or energy transmission, generating a sealing, onto a container and comprises at least one test unit, which is at least partly integrated in the sealing unit, for a monitoring of a sealing quality of the container sealed by the sealing unit, wherein the test unit comprises at least one temperature sensor for a detection of a sealing temperature, wherein the test unit comprises at least two, in particular several, temperature sensors and comprises a computing unit, in particular the aforementioned computing unit, for an evaluation of the test parameter detected by means of the temperature sensors, wherein the computing unit is configured to determine the sealing quality depending on a comparison of two values of the test parameter captured in at least two different measuring points which are assigned to the same container. Preferably the two temperature sensors are arranged in different positions at the heating unit and/or at the sealing tool. The temperature sensors are preferably arranged at the heating unit and/or at the sealing tool regularly along a longitudinal or main extension axis of the base body of the heating unit. Preferentially, the temperature sensors are arranged at the heating unit and/or at the sealing tool in an n-fold symmetry. In particular, “n” means the number of temperature sensors. For example, the temperature sensors are arranged at the heating unit and/or at the sealing tool offset relative to each other by 180° with a maximum number of two temperature sensors, by 120° with a maximum number of three temperature sensors, by 90° with a maximum number of four temperature sensors, etc. However, it is also conceivable, in particular depending on a field of application, that the temperature sensors are arranged at the heating unit and/or at the sealing tool in an irregular distribution, or that the temperature sensors are arranged in segment-wise differing fashion, like for example arranged in a regular distribution in one segment, arranged in an irregular distribution in a further segment, etc. Further arrangements of temperature sensors, deemed expedient by someone skilled in the art, which are in particular useful for a determination of a sealing quality, are also conceivable. Advantageously, easy evaluation of the test parameter is possible. In particular, a determination precise in terms of position, in particular of temperature fluctuations or temperature differences in different areas, is enabled.

It is furthermore conceivable, in particular in at least one implementation of the sealing device according to the invention, that the test unit comprises a computing unit, in particular the aforementioned computing unit, for an evaluation of the test parameter captured by means of the temperature sensor, wherein the computing unit is configured to evaluate a temporal progression of the test parameter in order to determine the sealing quality. It is conceivable that in an alternative implementation, for solving the task of enabling structurally simple and reliable determination of a sealing quality, the sealing device is realized independently from the arrangement of the temperature sensor in a sensor material recess. Preferably, in the alternative implementation, in particular in the implementation realized independently from the arrangement of the temperature sensor in a sensor material recess, the sealing device comprises at least one sealing unit for a force and/or energy transmission, generating a sealing, onto a container and comprises at least one test unit, which is at least partly integrated in the sealing unit, for a monitoring of a sealing quality of the container sealed by the sealing unit, wherein the test unit comprises at least one temperature sensor for a detection of a sealing temperature, wherein the test unit comprises a computing unit, in particular the aforementioned computing unit, for an evaluation of the test parameter captured by means of the temperature sensor, wherein the computing unit is configured to evaluate a temporal progression of the test parameter in order to determine the sealing quality. It is conceivable that the computing unit is configured to evaluate a temporal progression of the test parameter depending on values of the test parameter captured by means of a single temperature sensor, or that the computing unit is configured to evaluate a temporal progression of the test parameter depending on values of the test parameter captured by a plurality of temperature sensors. Advantageously, precise fault recognition is enabled. Moreover, advantageously a prediction function is enabled.

It is furthermore conceivable, in particular in at least one implementation of the sealing device according to the invention, that the test unit comprises at least one proofing unit at least for a proofing of a receiving space of the sealing unit, in which at least the temperature sensor is arranged. It is conceivable that in an alternative implementation, for solving the task of enabling structurally simple and reliable determination of a sealing quality, the sealing device is realized independently from the arrangement of the temperature sensor in a sensor material recess. Preferably, in the alternative implementation, in particular in the implementation realized independently from the arrangement of the temperature sensor in a sensor material recess, the sealing device comprises at least one sealing unit for a force and/or energy transmission, generating a sealing, to a container and comprises at least one test unit, which is at least partly integrated in the sealing unit, for a monitoring of a sealing quality of the container sealed by the sealing unit, wherein the test unit comprises at least one temperature sensor for a detection of a sealing temperature, wherein the test unit comprises at least one proofing unit at least for a proofing of a receiving space of the sealing unit, in which at least the temperature sensor is arranged. Preferably the proofing unit comprises at least one, in particular ceramic, pass-through element for a passage of electric lines, in particular of the heating unit or of the temperature sensor. In particular, the proofing unit comprises for each temperature sensor its own pass-through element that is assigned to the temperature sensor for a passage of a line of the respective temperature sensor for the purpose of a connection to the computing unit and/or to a power supply. The proofing unit comprises at least one cable-guiding element, which is in particular arranged at the pass-through element, like for example a cable bushing or the like, for guiding a line of the heating unit and/or of the temperature sensor, which is arranged in the pass-through element, out of the pass-through element, wherein the cable-guiding element preferably has a proofing or strain-relief function. The proofing unit preferentially comprises at least one proofing element, which is arranged at an interface between the sealing holder and the sealing tool, in particular for a proofing of the receiving space delimited by the sealing holder and the sealing tool. Preferentially the proofing unit comprises, in particular depending on a number of contact lines/contact points between the sealing holder and the sealing tool, a plurality of proofing elements, which are arranged at an interface between the sealing holder and the sealing tool. Advantageously, secure operation of the sealing device in a humid operational environment is enabled, wherein reliable determination of the sealing quality can be realized.

Beyond this, a sealing station is proposed, in particular for a filling and/or production installation, comprising at least one sealing carrier for a support of at least one sealing device according to the invention, in particular of several sealing devices according to the invention, comprising at least one sealing device according to the invention and at least one sealing support for supporting the container, in particular several containers, during the sealing. The filling and/or production installation in particular comprises at least one filling station for a filling of the containers with the product for packaging. Optionally, the filling and/or production installation comprises at least one production station for production, processing or treatment of the product for packaging or of the containers. The filling and/or production installation preferably comprises at least one conveying installation, in particular a belt-conveying installation, for a transport of the containers with the product for packaging at least from the filling station to the sealing station. The filling station or a further station of the filling and/or production installation is configured to arrange the container cover at the receiving unit filled with the product for packaging, in particular to put the container cover onto the receiving unit filled with the product for packaging. The sealing station preferably comprises a frame unit for arranging the sealing station at the conveying installation. The sealing support and the sealing carrier are preferably fastened on the frame unit. Preferably the sealing support is configured to support the conveying installation that transports the container and/or to align the frame unit relative to the conveying installation, in particular such that, when the conveying installation stops, the container assumes a pre-set sealing position relative to the sealing carrier. The sealing carrier in particular comprises at least one sealing head receptacle for receiving, in particular suspending, the sealing device. The sealing carrier is in particular configured to adapt the sealing device and the sealing position of the container to each other. Preferentially the sealing carrier comprises several sealing head receptacles for receiving several sealing devices, in particular structurally identical sealing devices. With respect to a designated transport direction of the containers through the sealing station, the sealing devices may be arranged side by side, in particular for containers transported by several parallel-running conveying installations of the filling and/or production installation, and or may be arranged behind one another, in particular for containers transported by the same conveying installation. The sealing devices may be realized so as to be actuatable individually or in combination. The implementation according to the invention allows providing an advantageously robust and reliable sealing station, which is in particular at the same time adaptable in an advantageously simple and flexible manner to different container geometries.

Furthermore, a method for producing a sealing device according to the invention is proposed. Preferably in at least one method step of the method, the ceramic heating unit is fixed to the sealing holder. Particularly preferentially the ceramic heating unit is fastened to the sealing holder in a form-fitting manner. In particular, the ceramic heating unit is inserted into a depression, in particular the aforementioned depression, and/or is adjoined to an abutment surface of the sealing holder that is intended for this. Preferably the holder is arranged at the ceramic heating unit. In a state when the holder adjoins the ceramic heating unit, the holder is preferably fixed to the sealing holder, in particular by means of at least one screw. Preferably the holder extends over several of the ceramic base bodies, in particular for simultaneous fixing of these ceramic base bodies. Optionally, a further holder of the sealing device is used for fixing ceramic base bodies which are not fixed by the holder. If the sealing tool is embodied as an attachment, the sealing tool may be fixed by the holder together with the ceramic heating unit, or may be fastened to the ceramic heating unit after a fixing of the ceramic heating unit. The implementation according to the invention advantageously allows reliable protection of the heating conductor against damaging. In particular, even in case of damaging of the ceramic base body, for example if material has splintered off, it is advantageously possible to reliably continue using the ceramic heating unit. In particular, a risk of damaging of the heating conductor can be kept advantageously low.

It is moreover proposed that in at least one method step of the method, in a hardened state of the ceramic base body, the at least one ceramic base body is adapted to a designated container geometry of the container by material removal. Preferably the ceramic base body is produced from a hardened ceramic pre-product having a standardized shape and/or size. The hardened ceramic pre-product is converted into the ceramic base body, for example, by milling, grinding, lapping, honing, drilling or the like. In particular, a material thickness of the hardened ceramic pre-product is reduced by the material removal in a direction perpendicular to a course of the heating conductor. The implementation of the method according to the invention allows advantageously precise adaption of the ceramic heating unit to the container geometry. It is in particular possible to copy specific container geometries in an advantageously precise manner. In particular, a volume of the ceramic base body, and hence a resulting heat capacity, can be kept advantageously small. In particular, advantageously quick heating and cooling of the ceramic base body is enabled. In particular, advantageously reliable and quick temperature regulation of the ceramic base body is enabled. In particular, advantageous adaption of the ceramic heating unit is possible in case of a changeover of the sealing device. In particular, a number of additionally acquired ceramic heating units can be kept advantageously low.

It is further proposed that in at least one method step of the method, in which the ceramic base body is present in a hardened state of the ceramic base body, a temperature sensor, in particular the aforementioned temperature sensor, is inserted into a sensor material recess, in particular the aforementioned sensor material recess, in particular a bore, of the at least one hardened ceramic base body. Preferably the ceramic base body is provided with the sensor material recess, in particular by drilling, on a side of the ceramic base body that faces away from the sealing tool. Particularly preferably the sensor material recess is produced on the same side of the ceramic base body on which the electrical connection is arranged. It is possible that per each ceramic base body one single temperature sensor or several temperature sensors, in particular distributed over several sensor material recesses, is/are arranged at the ceramic base bodies. Especially preferentially, at least one temperature sensor is inserted into each ceramic base body of the ceramic heating unit, which encompasses one of the heating conductors. Following insertion of the temperature sensor, the sensor material recess is preferably closed by a hardenable mass. By the implementation according to the invention, the temperature sensor can be arranged in an advantageously flexibly selectable point of the ceramic base body. It is in particular possible to decide a suitable position of the temperature sensor not before mounting the ceramic heating unit. In particular, a number of temperature sensors within the ceramic heating unit may be adapted, in particular increased, at any time with advantageously little input.

The sealing device according to the invention, the sealing station according to the invention and/or the method according to the invention shall herein not be limited to the application and implementation described above. In particular, in order to fulfill a functionality that is described here, the sealing device according to the invention, the sealing station according to the invention and/or the method according to the invention may comprise a number of individual elements, components and units as well as method steps that differs from a number given here. Moreover, with regard to the value ranges given in the present disclosure, values situated within the limits mentioned shall also be considered as disclosed and as applicable according to requirements.

### BRIEF DESCRIPTION OF THE DRAWINGS

Further advantages will become apparent from the following description of the drawings. In the drawings eleven exemplary embodiments of the invention are illustrated. The drawings, the description and the claims contain a plurality of features in combination. Someone skilled in the art will purposefully also consider the features separately and will find further expedient combinations.

It is shown in:

FIG. 1 a schematic illustration of a sealing station according to the invention,

FIG. 2 a schematic illustration of a sealing device according to the invention,

FIG. 3 a schematic illustration of a ceramic heating unit of the sealing device according to the invention,

FIG. 4 a schematic perspective sectional view of the sealing device according to the invention,

FIG. 5 a schematic flowchart of a method for producing the sealing device according to the invention,

FIG. 6 a schematic flowchart of a method according to the invention for operating the sealing device according to the invention,

FIG. 7 a schematic perspective sectional view of a further implementation of a sealing device according to the invention, with an insulation element,

FIG. 8 a schematic illustration of another implementation of a sealing device according to the invention,

FIG. 9 a schematic perspective sectional view of an alternative implementation of a sealing device according to the invention, in which a centering unit is realized at the same time as a holder for a ceramic heating unit,

FIG. 10 a schematic illustration of the alternative implementation of the sealing device according to the invention, with a view onto a sealing tool of this sealing device according to the invention,

FIG. 11 a schematic illustration of a further alternative implementation of a sealing device according to the invention, with a ceramic heating unit embedded in a sealing holder,

FIG. 12 a schematic perspective sectional view of the further alternative implementation of the sealing device according to the invention,

FIG. 13 a schematic illustration of an alternative ceramic heating unit of a sealing device according to the invention,

FIG. 14 a schematic illustration of a further alternative ceramic heating unit of a sealing device according to the invention,

FIG. 15 a schematic illustration of a differently realized ceramic heating unit of a sealing device according to the invention,

FIG. 16 a schematic perspective sectional view of an alternative implementation of the sealing device according to the invention, and

FIG. 17 the sealing device according to the invention of FIG. 16, with an alternative arrangement of a temperature sensor, in a schematic illustration.

### DETAILED DESCRIPTION

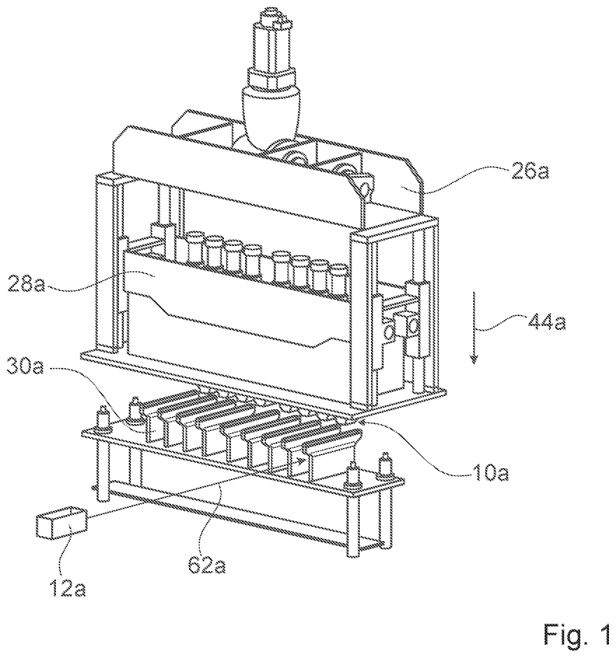

FIG. 1 shows a sealing station 26a. The sealing station 26a is in particular configured for a filling and/or production installation. The sealing station 26a comprises at least one sealing device 10a for a sealing of a container 12a. The container 12a is transported, by a conveying installation of the filling and/or production installation, preferably along a transport direction 62a, through the sealing station 26a in an intermittent manner, wherein the container 12a is in particular stopped at a sealing position within the sealing station 26a for an execution of the sealing of the container 12a. Preferably the sealing station 26a comprises several, in the present case for example eight, sealing devices 10a, which are in particular construction-wise identical. The sealing devices 10a are in particular arranged parallel with respect to the transport direction 62a of the container 12a through the sealing station 26a, in particular for a parallel sealing of several containers 12a. The sealing station 26a comprises at least one sealing carrier 28a for supporting at least the one sealing device 10a, preferably several, in particular all sealing devices 10a, of the sealing station 26a. The sealing station 26a comprises a sealing support 30a for a support of the container 12a, in particular of several containers 12a simultaneously, during the sealing. The sealing station 26a preferably has at least one operation mode in which the sealing is carried out by the sealing station 26a in a fully automated manner. Optionally the sealing station 26a comprises at least one input and/or output unit, in particular at least one display, for checking the sealing and/or for an adaption of a process parameter of the sealing station 26a by a user.

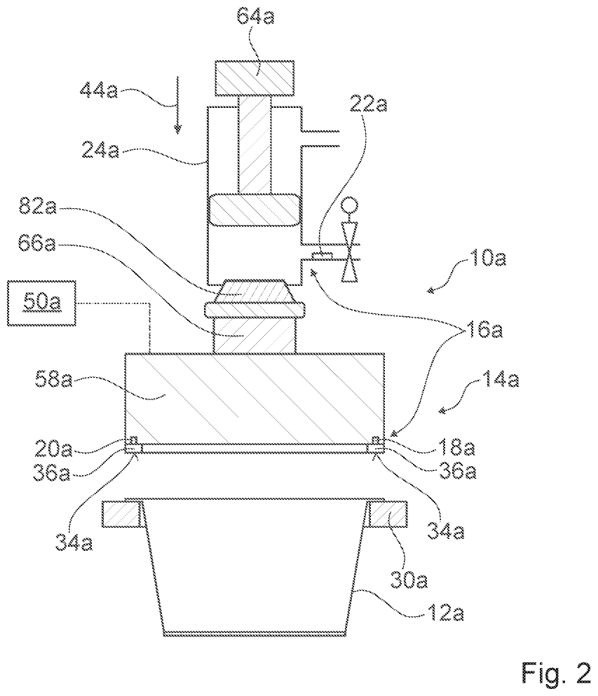

FIG. 2 shows a sectional view of the sealing device 10a, in particular in a plane perpendicular to the transport direction 62a. The sealing device 10a is in particular a sealing head. The sealing device 10a is configured for a sealing of the container 12a. The sealing device 10a is configured for a sealing of the container 12a by putting a container cover onto a receiving unit of the container 12a. The sealing device 10a comprises at least one sealing unit 14a for a force and/or energy transmission to the container 12a, which generates a sealing. The sealing device 10a, in particular the sealing unit 14a, comprises at least one sealing tool 34a. The sealing tool 34a forms a ring-shaped sealing zone for a physical contact with the container 12a. The sealing device 10a, in particular the sealing unit 14a, comprises at least one ceramic heating unit 36a for a heating of the sealing zone that generates a sealing. The sealing device 10a, in particular the sealing unit 14a, comprises a sealing holder 58a for an accommodation of the ceramic heating unit 36a. The ceramic heating unit 36a at least partly forms the sealing tool 34a with the sealing zone for a direct contact with the container 12a.

The sealing device 10a, in particular the sealing unit 14a, comprises at least one drive element 64a, in particular a servomotor. The drive element 64a is preferably mechanically, hydraulically and/or pneumatically coupled with the sealing holder 58a. The drive element 64a is in particular configured for a displacement of the sealing holder 58a, together with the sealing tool 34a that is fastened thereon, along a sealing direction 44a of the sealing device 10a, in particular in order to bring the sealing tool 34a into physical contact with the container 12a. The sealing direction 44a is preferably at least substantially perpendicular to the transport direction 62a of the container 12a. The ceramic heating unit 36a is in particular arranged on a side of the sealing holder 58a facing away from the drive element 64a.

The sealing device 10a comprises at least one test unit 16a, which is at least partially integrated in the sealing unit 14a. The test unit 16a is configured for a monitoring of a sealing quality of the container 12a sealed by the sealing unit 14a. The test unit 16a comprises at least one temperature sensor 18a for a detection of a sealing temperature. The test unit 16a comprises at least one further temperature sensor 20a for a location-specified detection of the sealing temperature. The temperature sensor 18a and/or the further temperature sensor 20a are/is preferably arranged at the ceramic heating unit 36a and/or at the sealing tool 34a. The test unit 16a comprises at least one press-on sensor 22a for a detection of a sealing force and/or of a sealing pressure. The test unit 16a comprises a pneumatic cylinder 24a, in or at which the press-on sensor 22a is arranged. The pneumatic cylinder 24a is in particular arranged between the drive element 64a and the sealing holder 58a. For example, the drive element 64a couples with a piston of the pneumatic cylinder 24a, wherein a cylinder housing of the pneumatic cylinder 24a, which accommodates the piston, is connected to the sealing holder 58a either directly or via a transmission unit 66a of the sealing unit 14a indirectly. Alternatively, the drive element 64a couples with the cylinder housing of the pneumatic cylinder 24a and the piston of the pneumatic cylinder 24a couples with the sealing holder 58a either directly or via the transmission unit 66a of the sealing unit 14a. The press-on sensor 22a is in particular arranged in a feed line to the cylinder housing of the pneumatic cylinder 24a. The press-on sensor 22a is in particular arranged in a volume of the pneumatic cylinder 24a which is closed during the sealing, and is in particular configured for measuring a gas pressure within the pneumatic cylinder 24a during the sealing.

The sealing device 10a comprises a control or regulation unit 50a for a controlling or regulation of a temperature of the ceramic heating unit 36a. The control or regulation unit 50a is in particular configured to adjust or to regulate the sealing temperature via the temperature of the ceramic heating unit 36a. The control or regulation unit 50a is in particular configured for a controlling or regulation of the drive element 64a. The control or regulation unit 50a is in particular configured to adjust or regulate the sealing force and/or the sealing pressure.

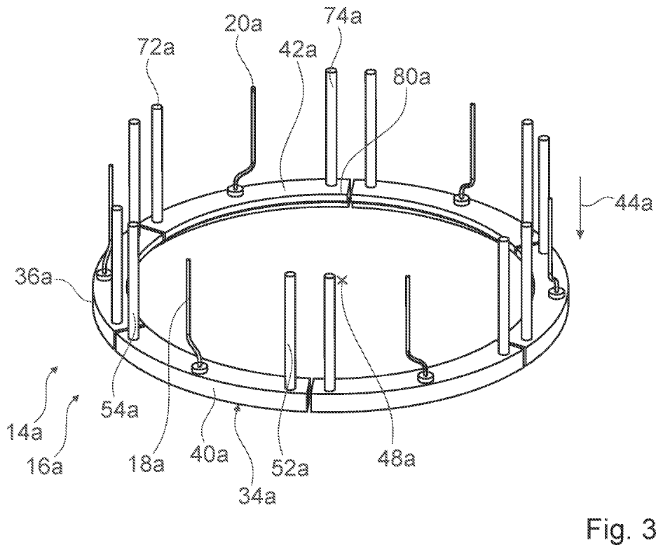

FIG. 3 shows the ceramic heating unit 36a. The ceramic heating unit 36a comprises a heating conductor (not shown here in detail), which is in a heating region of the ceramic heating unit 36a surrounded at least substantially completely by a heat-conducting ceramic base body 40a of the ceramic heating unit 36a. The at least one ceramic base body 40a is made of silicon nitride or aluminum nitride. The heating conductor is preferably made of silicon nitride or aluminum nitride doped with an additive for increasing an electrical conductivity relative to the ceramic base body 40a. The additive in particular amounts to less than 50%, preferably less than 25%, of a total mass of the heating conductor. The ceramic heating unit 36a preferably comprises electrical connections 52a, 54a via which the heating conductor is electrically connected in particular with the control or regulation unit 50a. The electrical connections 52a, 54a in particular extend at least substantially parallel to the sealing direction 44a. The at least one ceramic base body 40a at least partially forms the sealing tool 34a with the sealing zone for a direct contact with the container 12a. The sealing zone is here in particular realized in a circular-annulus shape. The electrical connections 52a, 54a are in particular arranged on a side of the ceramic base body 40a facing away from the sealing tool 34a.

The ceramic heating unit 36a comprises at least one further ceramic base body 42a, in the present case exemplarily five further ceramic base bodies 42a. The further ceramic base body 42a is realized separately from the ceramic base body 40a. The further ceramic base body 42a is in particular formed so as to be construction-wise identical to the ceramic base body 40a. The ceramic base body 40a and the further ceramic base body 42a in particular each form a subsegment of the sealing zone. In a plane perpendicular to a sealing direction 44a, the ceramic base body 40a and the further ceramic base body 42a are arranged at least substantially at the same distance from a geometric center 48a of the ceramic heating unit 36a, in particular of the ring-shaped sealing zone. Within the further ceramic base body 42a, the ceramic heating unit 36a in particular comprises a further heating conductor. The further heating conductor is preferably realized separately from the heating conductor, and is electrically connected, in particular to the control or regulation unit 50a, via further electrical connections 72a, 74a of the ceramic heating unit 36a. The further electrical connections 72a, 74a are preferably realized within the sealing unit 14a separately from the electrical connections 52a, 54a of the heating conductor. The control or regulation unit 50a is configured for separate controlling or regulation of a temperature of the different ceramic base bodies 40a, 42a. The control or regulation unit 50a may comprise several independent current and/or voltage sources and/or switching elements for a distribution of an electrical current flux from a current and/or voltage source onto the different electrical connections 52a, 54a, 72a, 74a. Depending on an application, the further electrical connections 72a, 74a and the electrical connections 52a, 54a may be connected to the control or regulation unit 50a so as to be electrically separate from one another or may be connected parallel or in series with one another. In particular, each ceramic base body 40a, 42a that surrounds one of the heating conductors is assigned at least one of the temperature sensors 18a, 20a. In particular, the temperature sensor 18a is arranged in a sensor material recess of the ceramic base body 40a. In particular, the further temperature sensor 20a is arranged in a sensor material recess of the further ceramic base body 42a. The sensor material recesses are preferably arranged on the same side of the ceramic base bodies 40a, 42a as the respective electrical connections 52a, 54a, 72a, 74a.

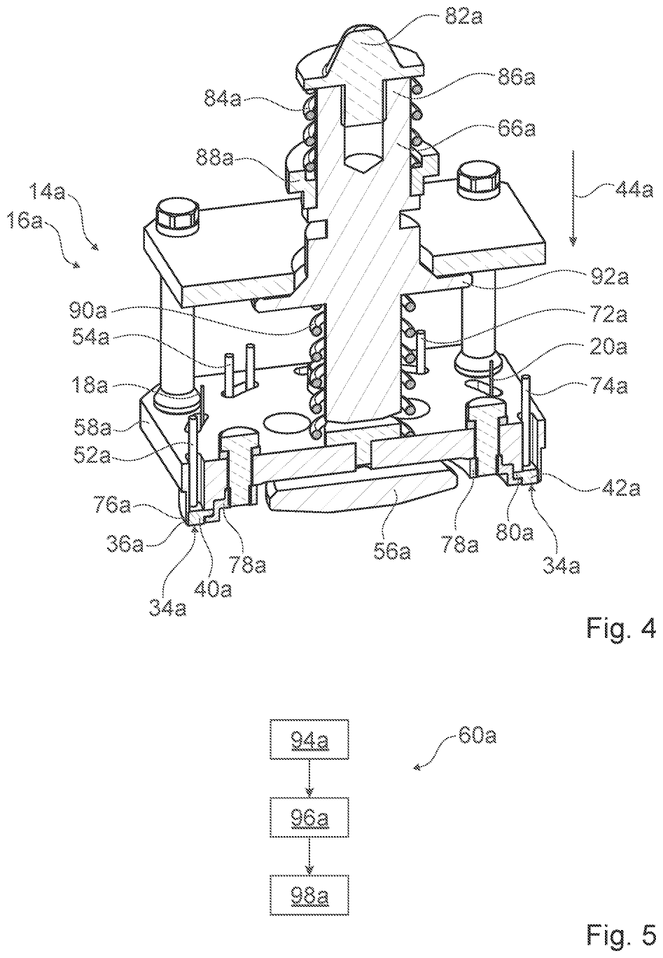

FIG. 4 shows a sectional view of the sealing device 10a in a plane parallel to the sealing direction 44a. The sealing holder 58a in particular has a plate-shaped base body comprising preferably more than 50%, in particular more than 75%, of a total volume of the sealing holder 58a. The sealing holder 58a is preferably made of metal, in particular of stainless steel. The sealing holder 58a preferably comprises a holding structure 76a, which is in particular configured for a form-fitting accommodation of the ceramic heating unit 36a in a direction perpendicular to the sealing direction 44a. The holding structure 76a in particular protrudes from the plate-shaped base body of the sealing holder 58a. The holding structure 76a is realized for example in a ring shape and surrounds the ceramic heating unit 36a in a plane that is perpendicular to the sealing direction 44a. The sealing device 10a preferably comprises a holder 78a. The holder 78a is in particular configured for fixing the ceramic heating unit 36a at the sealing holder 58a in a form-fitting fashion, in a direction parallel to the sealing direction 44a. For example, the holder 78a is embodied as a holding ring. The holder 78a is preferably made of metal, in particular of a stainless steel. A maximum transverse extent, in particular outer diameter, of the holder 78a perpendicular to the sealing direction 44a is in particular smaller than a maximum transverse extent of the ceramic heating unit 36a. Preferably the ceramic base bodies 40a, 42a of the ceramic heating unit 36a form a projection 80a, which is in particular arranged spaced apart from the side of the respective base body 40a, 42a which faces towards the sealing tool 34a and/or forms the sealing tool 34a. The projection 80a is in particular arranged on a side of the ceramic base body 40a, 42a which faces towards the geometric center 48a of the ceramic heating unit 36a. In particular, the projection 80a is arranged, in particular clamped-in, parallel to the sealing direction 44a between the sealing holder 58a, in particular the plate-shaped base body of the sealing holder 58a and/or an adjoining structure of the sealing holder 58a that protrudes from the plate-shaped base body, and the holder 78a. The holder 78a is in particular fixed at the sealing holder 58a by screws penetrating the sealing holder 58a. The sealing holder 58a preferably has connection material recesses, through which the electrical connections 52a, 54a, 72a, 74a and connections for the temperature sensors 18a, 20a are guided from the ceramic heating unit 36a through the sealing holder 58a.

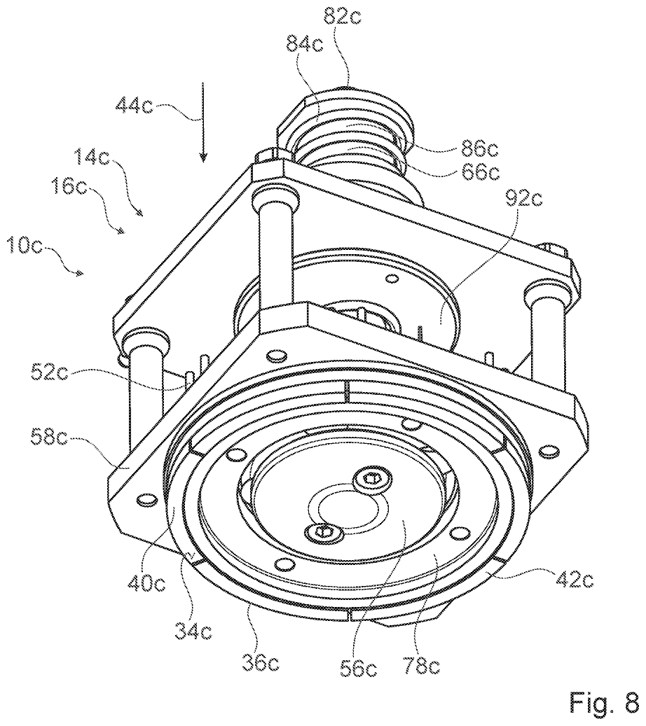

The sealing device 10a comprises a centering unit 56a for a securing of the container 12a during a sealing process. The centering unit 56a is in particular realized as a domed disk. The centering unit 56a is arranged in a plane perpendicular to the sealing direction 44a, in particular within the ceramic heating unit 36a and in particular within the holder 78a. In particular, the centering unit 56a is arranged concentrically with the ceramic heating unit 36a and in particular with the holder 78a. A dome of the centering unit 56a is formed parallel to the centering unit 56a, in particular away from the sealing holder 58a and in particular facing towards the container 12a. The centering unit 56a is in particular screwed to the sealing holder 58a (cf. in this regard FIG. 8).

The transmission unit 66a comprises, for example, a rigid transmission rod 86a, which is in particular configured for a force and/or pressure transmission from the drive element 64a via the pneumatic cylinder 24a to the sealing holder 58a. A maximum longitudinal extent of the transmission rod 86a is in particular arranged at least substantially parallel to the sealing direction 44a. In particular, the transmission unit 66a comprises a conical upper part 82a, which is arranged at an end of the transmission rod 86a facing away from the sealing holder 58a. In a plane perpendicular to the sealing direction 44a, the conical upper part 82a is preferably surrounded by the cylinder housing of the pneumatic cylinder 24a. Preferably the transmission unit 66a comprises at least one spring 84a, which is arranged around the transmission rod 86a and attacks at the conical upper part 82a and at a mount 88a of the transmission unit 66a. The mount 88a is preferably configured for an insertion of the sealing device 10a in the sealing carrier 28a. Preferably the transmission unit 66a comprises at least one further spring 90a, which is arranged around the transmission rod 86a and attacks at the sealing holder 58a and at an abutment element 92a of the transmission rod 86a. The abutment element 92a in particular defines a zero position of the transmission rod 86a, in which there is in particular no force and/or pressure transmission from the drive element 64a to the container 12a, even if the sealing tool 34a is in physical contact with the container 12a. Preferably, the transmission rod 86a is at least in the zero position arranged spaced apart from the sealing holder 58a.

FIG. 5 shows a method 60a for producing the sealing device 10a. The method 60a for producing the sealing device 10a preferably comprises an adaption step 94a. In the adaption step 94a preferably an, in particular standardized, pre-product of the ceramic heating unit 36a, in particular of the ceramic base bodies 40a, 42a, is provided. In the pre-product the ceramic base body 40a, 42a is in particular present in a state when already hardened, in particular by sintering and in particular completely. In the at least one adaption step 94a of the method 60a for producing the sealing device 10a, the at least one ceramic base body 40a, 42a is—in a hardened state of the ceramic base body 40a, 42a—adapted to a designated container geometry of the container 12a by material removal. In particular, a material thickness of the pre-product is reduced, in a direction perpendicular to the sealing direction 44a, to a designated material thickness of the ceramic base body 40a, 42a in this direction. The designated material thickness is preferably equal to a width of a designated sealing surface of the container 12a.

The method for producing the sealing device 10a preferably comprises a sensor insertion step 96a. In the sensor insertion step 96a of the method 60a for producing the sealing device 10a, the at least one ceramic base body 40a, 42a is present in a hardened state of the ceramic base body 40a, 42a. In the sensor insertion step 96a, in particular at least one sensor material recess is made, in particular drilled, into the ceramic base body 40a, 42a. Alternatively, the sensor material recess is made in the ceramic base body 40a, 42a in or before the adaption step 94a. In the sensor insertion step 96a, the temperature sensor 18a, 20a is inserted in the sensor material recess, in particular a bore, of the at least one hardened ceramic base body 40a, 42a. Optionally, after insertion of the temperature sensor 18a, 20a, the sensor material recess is filled and/or closed with a hardenable material.

The method 60a for producing the sealing device 10a in particular comprises an assembly step 98a. In the assembly step 98a, the ceramic heating unit 36a is arranged at the sealing holder 58a, and is in particular adjoined to the holding structure 76a along the holding structure 76a. In particular, the individual ceramic base bodies 40a, 42a are arranged along at least one closed path extending in a plane perpendicular to the sealing direction 44a. Preferably the ceramic base bodies 40a, 42a are arranged only slightly spaced apart from one another along the at least one closed path. The slight distance preferably corresponds to a maximally expected heat expansion of the ceramic base bodies 40a, 42a along the path at the sealing temperature, in particular including a safety factor. The ceramic heating unit 36a is in particular secured to the sealing holder 58a by means of the holder 78a.

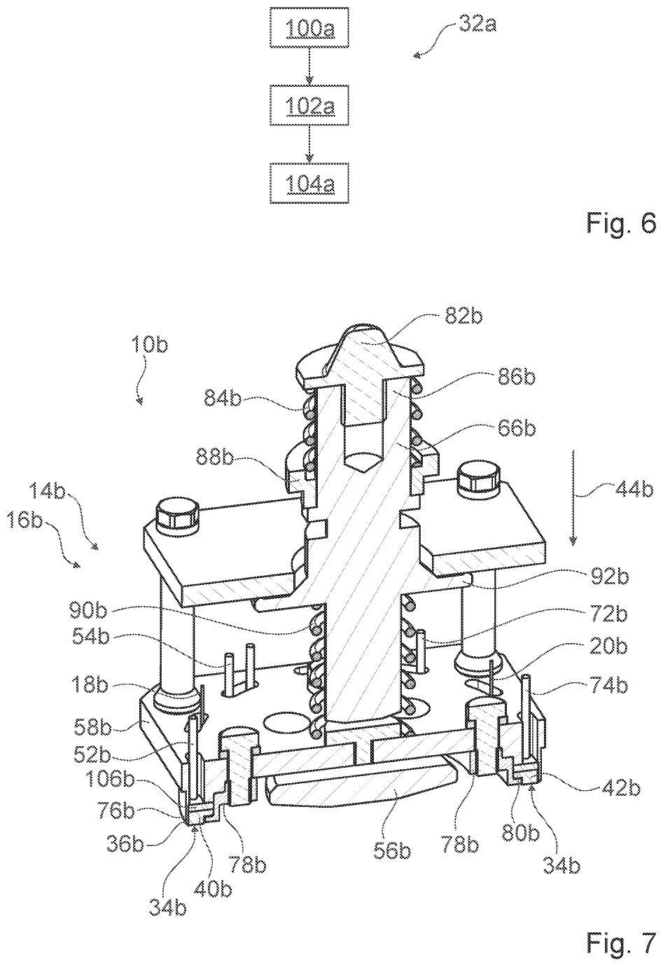

FIG. 6 shows a method 32a for an operation of the sealing device 10a and/or of a sealing station 26a. The method 32a for an operation of the sealing device 10a preferably comprises a detection step 100a. The detection step 100a is in particular carried out during the sealing of the container 12a. During the sealing carried out by the sealing unit 14a, the test unit 16a captures at least one test parameter for a determination of the sealing quality. The detection step 100a may start before the sealing and/or may continue beyond the end of the sealing, in particular in order to capture comparative values for a test value of the test parameter captured during the sealing. The test parameter is preferably realized as a sealing temperature of the ceramic heating unit 36a, which is in particular detected by the temperature sensors 18a, 20a of the test unit 16a. Particularly preferentially, by means of the temperature sensors 18a, 20a, the test unit 16a detects a specific sealing temperature for several ceramic base bodies 40a, 42a, in particular for each ceramic base body 40a, 42a. Preferably the test unit 16a comprises a computing unit (not shown here in detail) for an evaluation of the test parameter detected by the temperature sensors 18a, 20a. Preferably the computing unit is configured to determine the sealing quality depending on a comparison of two values of the test parameter, which are detected in at least two different measuring points assigned to the same container 12a. Alternatively or additionally, the computing unit is configured to evaluate a temporal progression of the test parameter for a determination of the sealing quality. Preferably the test unit 16a captures a sealing pressure measured by the press-on sensor 22a as an additional or alternative test parameter. The comparative value and/or the test value of the respective test parameter may in particular be detected as an individual value, in particular as a grab sample and/or as a temporal average value, as a series of values or as a quasi-continuous time progression.

The method 32a for an operation of the sealing device 10a preferably comprises an evaluation step 102a. The evaluation step 102a is in particular carried out by a computing unit of the test unit 16a. Optionally the computing unit processes raw data registered by the temperature sensors 18a, 20a and/or by the press-on sensor 22a to create the test parameter, for example by derivation, integration, averaging, difference calculation or the like. For example, the computing unit checks a drop in temperature of the ceramic base bodies 40a, 42a during a contact with the container 12a in order to obtain the sealing quality. The computing unit compares the test parameter(s), for example, with a nominal value of the test parameter. In the evaluation step 102a, the computing unit determines the sealing quality depending on a comparison of two values of the test parameter which were detected in at least two different measuring points assigned to the same container 12a. In particular, the computing unit compares a drop in temperature of the ceramic base body 40a to a drop in temperature of the further ceramic base body 42a. In particular, the computing unit infers deficient sealing quality if the test parameters for the different measuring points differ from each other by more than a tolerance value, which is in particular application-specific.

In the evaluation step 102a the computing unit determines the sealing quality of the container 12a depending on a value of the test parameter of a further container. The further container may be a container that is sealed by a further sealing device of the sealing station 26a at the same time as the container 12a, or may be a container that was sealed by the sealing device 10a prior to the container 12a. In particular, the computing unit infers deficient sealing quality if the test parameters for the different containers 12a differ by more than a tolerance value, which is in particular application-specific. Preferably, at least in a case of deficient sealing quality, the computing unit records the test parameter/s for further evaluation. In particular, the computing unit determines on the basis of the recorded test parameters, for example depending on a statistic accumulation, on the basis of a digital model of the sealing device 10a, on the basis of trend curves of the test parameter/s or the like, a possible error source in the sealing device 10a and/or in an upstream station of the filling and/or production installation. Possible error sources distinguished by the computing unit in particular comprise a defect within the sealing device 10a, for example a defect of one of the temperature sensors 18a, 20a and/or a defect of one of the heating conductors, faulty orientation of a container cover relative to a receiving unit of the container 12a, a contamination of the container 12a, a bend in the container cover of the container 12a, or the like. Criteria for distinguishing the error sources may herein be stored in a memory of the computing unit explicitly as comparison values and/or may have been created by the computing unit by machine learning.

The method 32a for an operation of the sealing device 10a preferably comprises an outputting step 104a. In particular, the test parameter and/or the sealing quality are/is outputted in the outputting step 104a. Preferably the computing unit is realized as part of the control or regulation unit 50a or at least has a data connection to the control or regulation unit 50a, in particular for a forwarding of the unprocessed test parameter and/or of an instruction, based on the test parameter, for a modified actuation of the sealing unit 14a. Additionally or alternatively, in the outputting step 104a the computing unit outputs the determined sealing quality to a user, for example via the input and/or output unit of the sealing station 26a and/or via an external outputting device, like for example a smartphone, a tablet computer, a display in a central installation control of the filling and/or production installation, or the like. Optionally the computing unit is data-technically connected with a sorting station of the filling and/or production installation, in particular for an automated sorting out of containers with deficient sealing quality.

In FIGS. 7 to 17 further exemplary embodiments of the invention are shown. The following descriptions and the drawings are substantially limited to the differences between the exemplary embodiments, wherein with regard to components having the same denomination, in particular regarding components having the same reference numerals, principally the drawings and/or the description of the other exemplary embodiments, in particular of FIGS. 1 to 6, may be referred to. In order to distinguish between the exemplary embodiments, the letter a has been added to the reference numerals of the exemplary embodiment in FIGS. 1 to 6. In the exemplary embodiments of FIGS. 7 to 17 the letter a has been substituted by the letters b to j.

FIG. 7 shows a sealing device 10b. The sealing device 10b is configured for a sealing of a container (not shown here). The sealing device 10b comprises at least one sealing unit 14b for a force and/or energy transmission, generating a sealing, to the container. The sealing device 10b, in particular the sealing unit 14b, comprises at least one sealing tool 14b, which forms a ring-shaped sealing zone for a physical contact with the container. The sealing device 10b, in particular the sealing unit 14b, comprises at least one ceramic heating unit 36b for a heating of the sealing zone, which generates a sealing. The ceramic heating unit 36b comprises a heating conductor (not shown here in detail), which is in a heating region of the ceramic heating unit 36b surrounded at least substantially completely by a thermally conductive ceramic base body 40b, 42b of the ceramic heating unit 36b. The sealing device 10b comprises at least one test unit 16b, which is integrated at least partly in the sealing unit 14b, for a monitoring of a sealing quality of the container sealed by the sealing unit 14b. The sealing device 10b in particular comprises an, in particular thermally insulating, insulation element 106b. The insulation element 106b is preferably made of a thermally insulating material. Preferentially the insulation element 106b is arranged, in particular in a direction parallel to a sealing direction 44b of the sealing device 10b, between the ceramic heating unit 36b and a sealing holder 58b of the sealing device 10b. The insulation element 106b is preferably realized in a ring shape. Preferably the insulation element 106b is additionally arranged between the ceramic heating unit 36b and a holding structure 76b of the sealing holder 58b, or an additional insulation element of the sealing device 10b is arranged between the ceramic heating unit 36b and a holding structure 76b of the sealing holder 58b. With regard to further features of the sealing device 10b, FIGS. 1 to 6 and their description may be referred to.

FIG. 8 shows a sealing device 10c. The sealing device 10c is configured for a sealing of a container (not shown here). The sealing device 10c comprises at least one sealing unit 14c for a force and/or energy transmission, generating a sealing, to the container. The sealing device 10c, in particular the sealing unit 14c, comprises at least one sealing tool 34c, which forms a ring-shaped sealing zone for a physical contact with the container. The sealing device 10c, in particular the sealing unit 14c, comprises at least one ceramic heating unit 36c for a heating of the sealing zone, which generates a sealing. The ceramic heating unit 36c comprises a heating conductor (not shown here in detail), which is in a heating region of the ceramic heating unit 36c surrounded at least substantially completely by a thermally conductive ceramic base body 40c, 42c of the ceramic heating unit 36c. The sealing device 10c comprises at least one test unit 16c, which is integrated at least partly in the sealing unit 14c, for a monitoring of a sealing quality of the container sealed by the sealing unit 14c. The ceramic heating unit 36c is arranged at a sealing holder 58c of the sealing device 10c in an exposed situation on an outer surface that points away from a geometric center of the ceramic heating unit 36c. In particular, the ceramic heating unit 36c is in a direction perpendicular to a sealing direction 44c of the sealing device 10c held exclusively by a holder 78c of the sealing device 10c, which in particular surrounds a projection of the ceramic base body 40c, 42c that points away from the outer surface. With regard to further features of the sealing device 10c, FIGS. 1 to 7 and their description may be referred to.

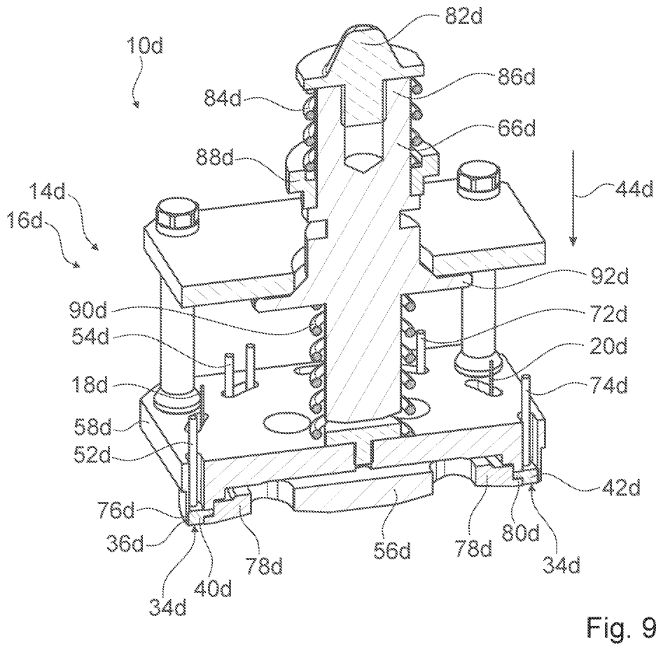

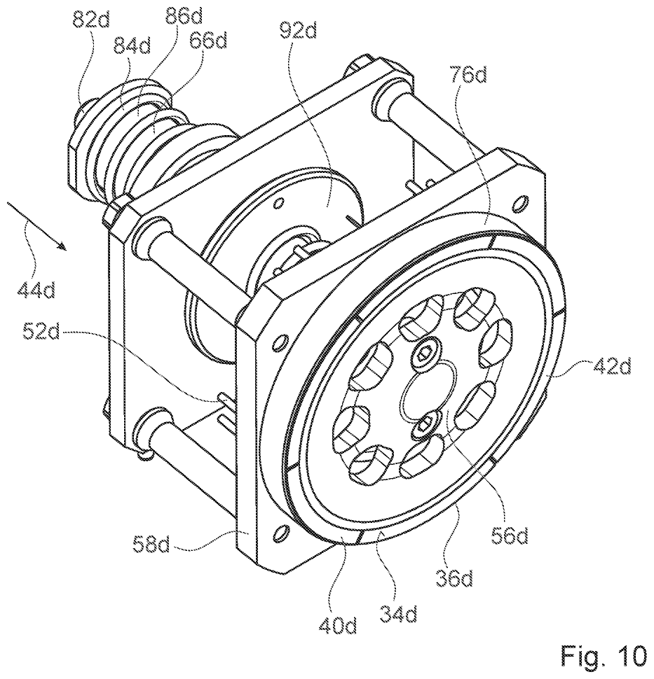

FIGS. 9 and 10 show a sealing device 10d. The sealing device 10d is configured for a sealing of a container (not shown here). The sealing device 10d comprises at least one sealing unit 14d for a force and/or energy transmission, generating a sealing, to the container. The sealing device 10d, in particular the sealing unit 14d, comprises at least one sealing tool 34d, which forms a ring-shaped sealing zone for a physical contact with the container. The sealing device 10d, in particular the sealing unit 14d, comprises at least one ceramic heating unit 36d for a heating of the sealing zone, which generates a sealing. The ceramic heating unit 36d comprises a heating conductor (not shown here in detail), which is in a heating region of the ceramic heating unit 36d surrounded at least substantially completely by a thermally conductive ceramic base body 40d, 42d of the ceramic heating unit 36d. The sealing device 10d comprises at least one test unit 16d, which is integrated at least partly in the sealing unit 14d, for a monitoring of a sealing quality of the container sealed by the sealing unit 14d. The sealing device 10d in particular comprises a holder 78d for fixing the ceramic heating unit 36d to a sealing holder 58d of the sealing device 10d. The sealing device 10d preferably comprises a centering unit 56d. The centering unit 56d in particular forms the holder 78d. The centering unit 56d in particular extends over an entire material recess of the ceramic heating unit 36d. The centering unit 56d is, in particular in a direction parallel to a sealing direction 44d of the sealing device 10d, arranged so as to overlap with the ceramic heating unit 36d. The ceramic heating unit 36d is arranged in a form-fitting manner between the centering unit 56d and the sealing holder 58d. In particular, a projection 80d of the ceramic base body 40d, 42d is arranged, in the direction parallel to the sealing direction 44d of the sealing device 10d, between a sealing holder 58d of the sealing device 10d and the centering unit 56d. With regard to further features of the sealing device 10d, FIGS. 1 to 8 and their description may be referred to.

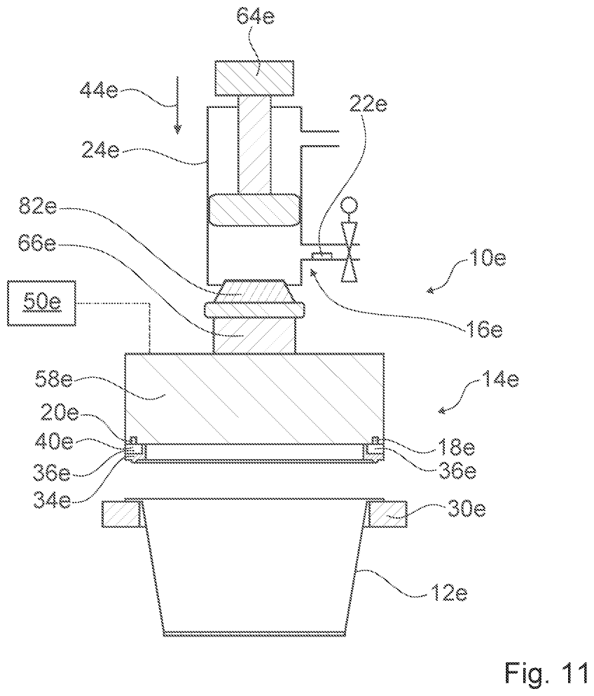

FIG. 11 shows a sealing device 10e. The sealing device 10e is configured for a sealing of a container 12e. The sealing device 10e comprises at least one sealing unit 14e for a force and/or energy transmission, generating a sealing, to the container 12e. The sealing device 10e, in particular the sealing unit 14e, comprises at least one sealing tool 34e, which forms a ring-shaped sealing zone for a physical contact with the container 12e. The sealing device 10e, in particular the sealing unit 14e, comprises at least one ceramic heating unit 36e for a heating of the sealing zone, which generates a sealing. The ceramic heating unit 36e comprises a heating conductor (not shown here in detail), which is in a heating region of the ceramic heating unit 36e surrounded at least substantially completely by a thermally conductive ceramic base body 40e of the ceramic heating unit 36e. The sealing device 10e comprises at least one test unit 16e, which is at least partly integrated in the sealing unit 14e, for a monitoring of a sealing quality of the container 12e sealed by the sealing unit 14e. The sealing tool 34e is realized as an attachment that is—in particular reversibly—arranged at the ceramic base body 40e. The sealing tool 34e is in particular made of metal, in particular of stainless steel. Preferentially the sealing tool 34e is screwed on a sealing holder 58e of the sealing device 10e. Alternatively, the sealing device 10e comprises a holder (not shown here) which is screwed on the sealing holder 58e and fixes the sealing tool 34e at the ceramic heating unit 36e in a form-fitting manner. With regard to further features of the sealing device 10e, FIGS. 1 to 10 and their description may be referred to.

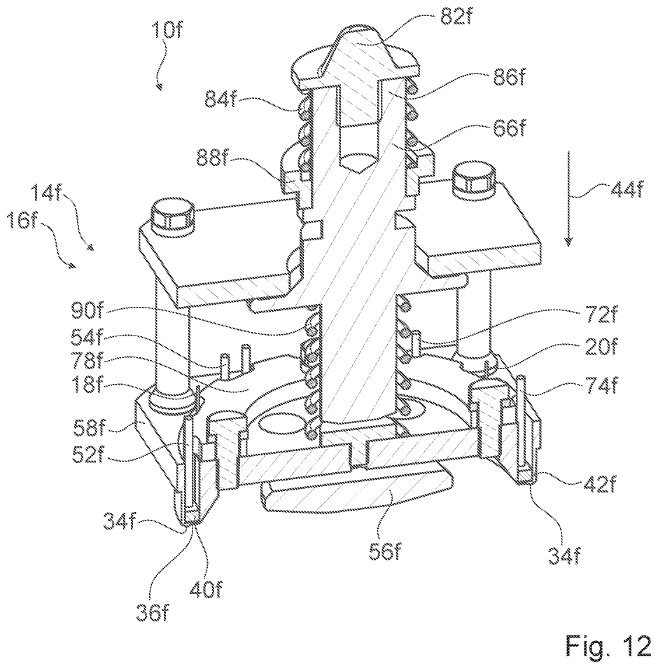

FIG. 12 shows a sealing device 10f. The sealing device 10f is configured for a sealing of a container (not shown here). The sealing device 10f comprises at least one sealing unit 14f for a force and/or energy transmission, generating a sealing, to the container. The sealing device 10f, in particular the sealing unit 14f, comprises at least one sealing tool 34f, which forms a ring-shaped sealing zone for a physical contact with the container. The sealing device 10f, in particular the sealing unit 14f, comprises at least one ceramic heating unit 36f for a heating of the sealing zone, which generates a sealing. The ceramic heating unit 36f comprises a heating conductor (not shown here in detail), which is in a heating region of the ceramic heating unit 36f surrounded at least substantially completely by a thermally conductive ceramic base body 40f of the ceramic heating unit 36f. The sealing device 10f comprises at least one test unit 16f, which is at least partly integrated in the sealing unit 14f, for a monitoring of a sealing quality of the container sealed by the sealing unit 14f. The ceramic heating unit 36f is in particular arranged within a sealing holder 58f of the sealing device 10f. In particular, a side of the sealing holder 58f that faces away from the sealing tool 34f has a depression which the ceramic heating unit 36f is arranged in. The sealing device 10f in particular comprises a holder 78f fixing the ceramic heating unit 36f in a form-fitting manner within the sealing holder 58f, in particular within the depression. The holder 78f is preferably arranged on a side of the sealing holder 58f that faces away from the sealing tool 34f. Preferably the holder 78f engages into the sealing holder 58f, in particular into the depression, in order to fix the ceramic heating unit 36f within the sealing holder 58f, in particular at a bottom of the depression. The sealing holder 58f forms the sealing tool 34f with the sealing zone. With regard to further features of the sealing device 10f, FIGS. 1 to 11 and their description may be referred to.

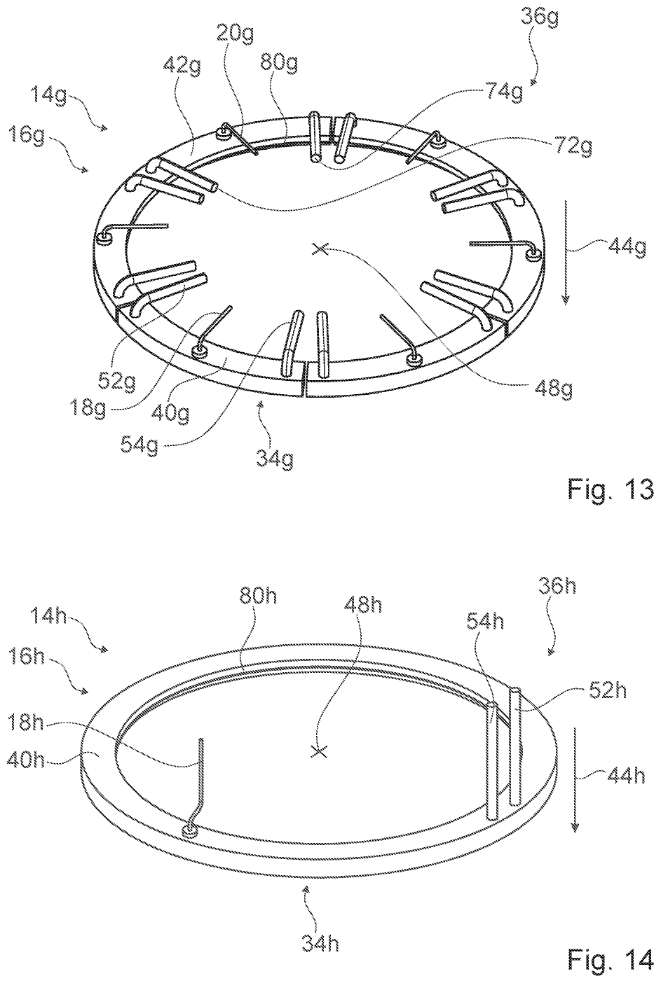

FIG. 13 shows a ceramic heating unit 36g for a sealing device of the kind described in the preceding passages. The ceramic heating unit 36f comprises a heating conductor (not shown here in detail), which is in a heating region of the ceramic heating unit 36g surrounded at least substantially completely by a thermally conductive ceramic base body 40g, 42g of the ceramic heating unit 36g. At least one electrical connection, in particular all electrical connections 52g, 54g, 72g, 74g of the ceramic heating unit 36g for the heating conductor extends/extend transversely, in particular perpendicularly, to a sealing direction 44g of the sealing device. The electrical connections 52g, 54g, 72g, 74g are in particular oriented to a middle axis of the ceramic heating unit 36g and/or of the sealing device, which runs parallel to the sealing direction 44g and extends through a geometric center 48g of the ceramic heating unit 36g. Preferably, connections for temperature sensors 18g, 20g of the sealing device, which are arranged in or at the ceramic base body 40g, 42g, are arranged and/or oriented in analogy to this. With regard to further features of the ceramic heating unit 36g and its arrangement in a sealing device, FIGS. 1 to 12 and their description may be referred to.

FIG. 14 shows a ceramic heating unit 36h for a sealing device of the kind described in the preceding passages. The ceramic heating unit 36h comprises a heating conductor (not shown here in detail), which is in a heating region of the ceramic heating unit 36h surrounded at least substantially completely by a thermally conductive ceramic base body 40h of the ceramic heating unit 36h. In particular, the ceramic base body 40h is embodied as a closed ring. In particular, the ceramic base body 40h is the only ceramic base body 40h of the ceramic heating unit 36h. With regard to further features of the ceramic heating unit 36h and its arrangement in a sealing device, FIGS. 1 to 13 and their description may be referred to.

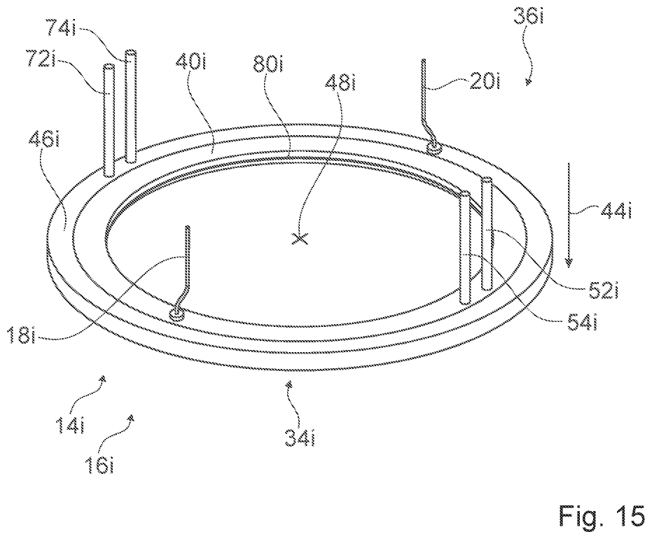

FIG. 15 shows a ceramic heating unit 36i for a sealing device of the kind shown in the preceding passages. The ceramic heating unit 36i comprises a heating conductor (not shown here in detail), which is in a heating region of the ceramic heating unit 36i surrounded at least substantially completely by a thermally conductive ceramic base body 40i of the ceramic heating unit 36i. The ceramic heating unit 36i comprises at least one additional ceramic base body 46i. The additional ceramic base body 46i is realized separately from the ceramic base body 40i. The ceramic base body 40i and the additional ceramic base body 46i are arranged on different closed paths around a geometric center 48i of the ceramic heating unit 36i, in particular of a ring-shaped sealing zone of the sealing device. The ceramic base body 40i and the additional ceramic base body 46i are in particular realized as rings or ring segments arranged concentrically with respect to the geometric center 48i. With regard to further features of the ceramic heating unit 36i and its arrangement in a sealing device, FIGS. 1 to 14 and their description may be referred to.

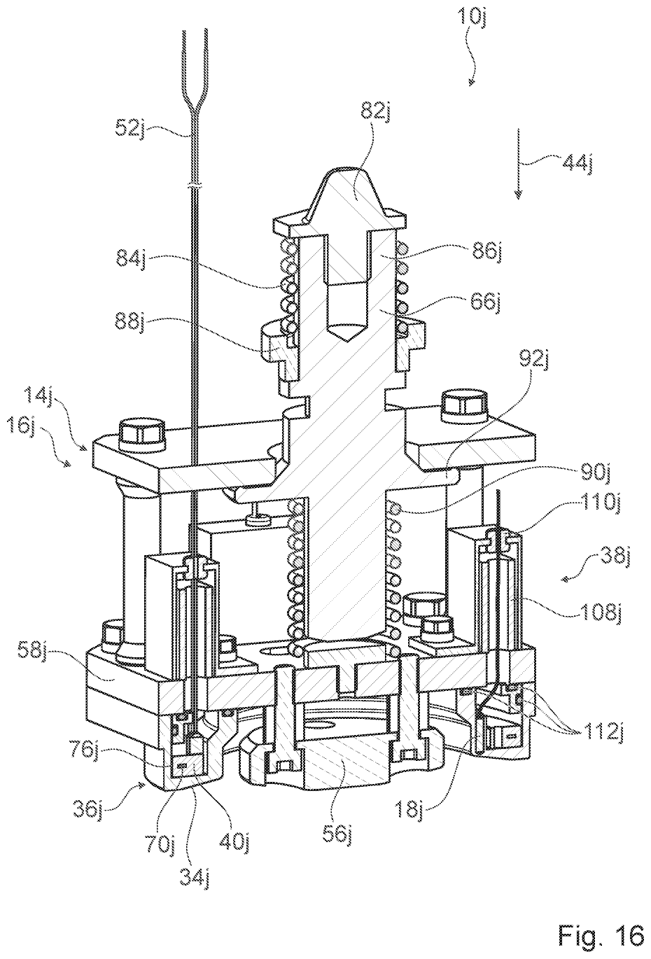

FIG. 16 shows a sectional view of an, in particular alternatively implemented, sealing device 10j. The sealing device 10j is configured for a sealing of a container (not shown here). The sealing device 10j comprises at least one sealing unit 14j for a force and/or energy transmission, generating a sealing, to the container. The sealing device 10j, in particular the sealing unit 14j, comprises at least one sealing tool 34j, which forms an, in particular ring-shaped, sealing zone for a physical contact with the container. The sealing device 10j, in particular the sealing unit 14j, comprises at least one ceramic heating unit 36j for a heating of the sealing zone, which generates a sealing. The ceramic heating unit 36j comprises a heating conductor 70j, which is in a heating region of the ceramic heating unit 36j surrounded at least substantially completely by a thermally conductive ceramic base body 40j of the ceramic heating unit 36j.

The sealing device 10j comprises at least one test unit 16j, which is at least partly integrated in the sealing unit 14j, for a monitoring of a sealing quality of the container sealed by the sealing unit 14j. The test unit 16j comprises at least one temperature sensor 18j, in particular a plurality of temperature sensors 18j, for a detection of a sealing temperature. The temperature sensor 18j is arranged in a sensor material recess of the sealing tool 34j of the sealing unit 14j, the sensor material recess of the sealing tool 34j being arranged in a proximity of the ceramic heating unit 36j. Preferably the sensor material recess is arranged outside the ceramic base body 40j of the ceramic heating unit 36j. The sensor material recess is preferably arranged directly in the sealing tool 34j. Preferentially the sensor material recess is arranged laterally offset from the ceramic heating unit 36j, preferably laterally offset from the ceramic base body 40j. Preferentially, viewed along a direction that runs at least substantially perpendicularly to a sealing direction 44j of the sealing device 10j, the sensor material recess is arranged within a region delimited by the ceramic base body 40j. Preferentially, viewed along a direction that runs at least substantially perpendicularly to a sealing direction 44j of the sealing device 10j, the sensor material recess has a maximum distance relative to an outer surface of the ceramic base body 40j facing towards the sensor material recess, in particular towards the temperature sensor 18j arranged therein, that is in particular smaller than 25 mm, preferentially smaller than 10 mm and particularly preferentially smaller than 8 mm.

In a state when the temperature sensor 18j is arranged in the sensor material recess, viewed along the direction that runs at least substantially perpendicularly to a sealing direction 44j of the sealing device 10j, the temperature sensor 18j is arranged within the region delimited by the ceramic base body 40j. Preferentially the temperature sensor 18j is arranged in the sensor material recess of the sealing tool 34j in such a way that the temperature sensor 18j, in particular a temperature detecting region of the temperature sensor 18j, like for example a temperature sensor tip or the like, is arranged spaced apart from a sealing surface, in particular an outer sealing surface, of the sealing tool or from a contact plane of the sealing unit 14j at an, in particular maximum, distance that is in particular smaller than 10 mm, preferentially smaller than 5 mm and particularly preferentially smaller than 2 mm.

The test unit 16j preferably comprises at least one proofing unit 38j at least for a proofing of a receiving space of the sealing unit 14j, in which at least the temperature sensor 18j is arranged. The receiving space of the sealing unit 14j is preferably delimited by a sealing holder 58j of the sealing unit 14j and by the sealing tool 34j. Preferentially at least the ceramic base body 40j and the temperature sensor 18j are arranged in the receiving space. Preferably the proofing unit 38j comprises at least one, in particular ceramic, pass-through element 108j for a passage of electric lines, in particular electric lines of the heating unit 36j or of the temperature sensor 18j. The proofing unit 38j comprises at least one cable-guiding element 110j, which is in particular arranged at the pass-through element 108j, like for example a cable bushing or the like, for guiding a line of the heating unit 36j and/or of the temperature sensor 18j, which is arranged in the pass-through element 108j, out of the pass-through element 108j, wherein the cable-guiding element 110j preferably has a proofing or strain-relief function. The proofing unit preferentially comprises at least one proofing element 112j, which is arranged at an interface between the sealing holder 58j and the sealing tool 34j, in particular for a proofing of the receiving space that is delimited by the sealing holder 58j and the sealing tool 34j. Preferentially the proofing unit 38j comprises a plurality of proofing elements 112j arranged at the interface between the sealing holder 58j and the sealing tool 34j. With regard to further features of the sealing device 10j, FIGS. 1 to 15 and their description may be referred to.

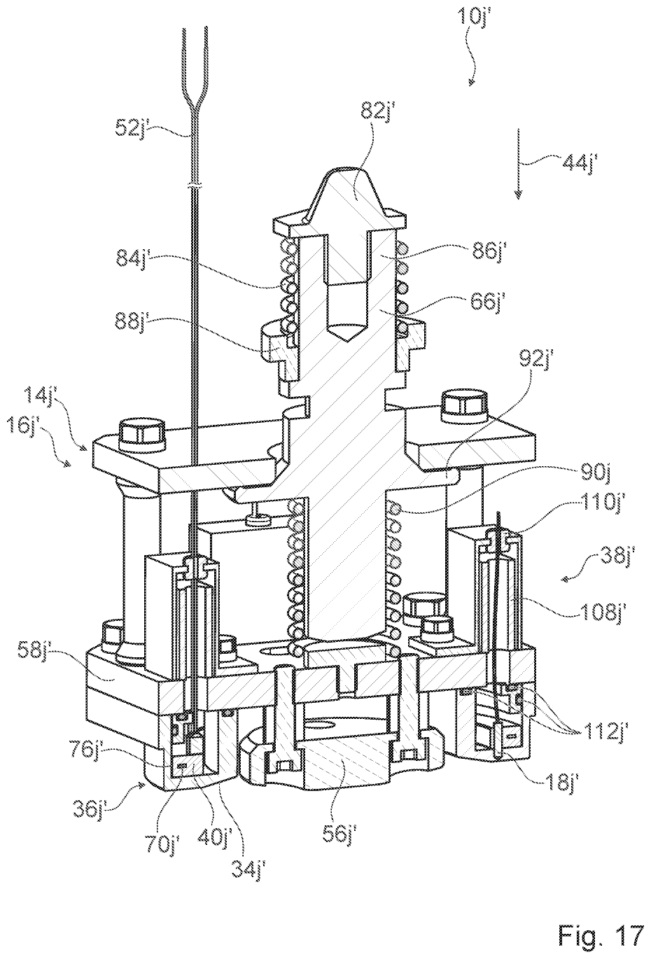

FIG. 17 shows an alternative arrangement of the sensor material recess of the sealing device 10j of FIG. 16; the reference numerals of FIG. 17 have therefore been given an apostrophe. Principally the sealing device 10j′ has an implementation that is analogous to the sealing device 10j of FIG. 16, a difference lying in particular in the arrangement of the sensor material recess of the sealing tool 34j′. Viewed along the sealing direction 44j′, the sensor material recess of the sealing tool 34j′ is arranged below the ceramic base body 40j′. Preferentially the ceramic base body 40j′ has a sensor material recess which the temperature sensor 18j′ is arranged in. The sensor material recess of the ceramic base body 40j′ is preferably arranged in alignment with the sensor material recess of the sealing tool 34j′, in particular along the sealing direction 44j′. Preferentially the temperature sensor 18j′ is arranged in the sensor material recess of the sealing tool 34j′ and in the sensor material recess of the ceramic base body 40j′. The temperature sensor 18j′ is arranged partly in the ceramic base body 40j′ and partly in the sealing tool 34j′. The temperature sensor 18j′ extends, preferably completely, through the ceramic base body 40j′ into the sealing tool 34j′. With regard to further features of the sealing device 10j′, FIGS. 1 to 16 and their description may be referred to.

1. A sealing device for sealing a container (12a; 12e), the sealing device comprising at least one sealing tool (34a; 34b; 34c; 34d; 34e; 34f; 34g; 34h; 34i), which forms a ring-shaped sealing zone for a physical contact with the container (12a; 12e), and with at least one ceramic heating unit (36a; 36b; 36c; 36d; 36e; 36f; 36g; 36h; 36i) for heating the sealing zone which generates a sealing, wherein the at least one ceramic heating unit (36a; 36b; 36c; 36d; 36e; 36f; 36g; 36h; 36i) comprises a heating conductor, which is in a heating region of the at least one ceramic heating unit (36a; 36b; 36c; 36d; 36e; 36f; 36g; 36h; 36i) surrounded substantially completely by a thermally conductive ceramic base body (40a, 42a; 40b, 42b; 40c, 42c; 40d, 42d; 40e, 42e; 40f, 42f; 40g, 42g; 40h; 40i, 46i) of the at least one ceramic heating unit (36a; 36b; 36c; 36d; 36e; 36f; 36g; 36h; 36i).

2. The sealing device according to claim 1, wherein the at least one ceramic heating unit (36a; 36b; 36c; 36d; 36e; 36f; 36g) comprises at least one further ceramic base body (42a; 42b; 42c; 42d; 42e; 42f; 42g) which is realized separately from the ceramic base body (40a; 40b; 40c; 40d; 40e; 40f; 40g), wherein, in a plane that is perpendicular to a sealing direction (44a; 44b; 44c; 44d; 44e; 44f; 44g), the ceramic base body (40a; 40b; 40c; 40d; 40e; 40f; 40g) and the further ceramic base body (42a; 42b; 42c; 42d; 42e; 42f; 42g) are arranged substantially at equal distances from a geometric center (48a; 48g) of the at least one ceramic heating unit (36a; 36b; 36c; 36d; 36e; 36f; 36g).

3. The sealing device according to claim 1, wherein the at least one ceramic heating unit (36i) comprises at least one additional ceramic base body (46i), which is realized separately from the ceramic base body (40i), wherein the ceramic base body (40i) and the additional ceramic base body (46i) are arranged on different closed paths around a geometric center (48i) of the at least one ceramic heating unit (36i).

4. The sealing device according to claim 2, further comprising a control or regulation unit (50a; 50e) for a separate controlling or regulation of a temperature of the ceramic base bodies (40a, 42a; 40b, 42b; 40c, 42c; 40d, 42d; 40e, 42e; 40f, 42f; 40g, 42g; 40h; 40i, 46i).

5. The sealing device according to claim 1, wherein at least one electrical connection (52g, 54g) of the at least one ceramic heating unit (36g) for the heating conductor extends transversely to a sealing direction (44g).

6. The sealing device according to claim 1, wherein the at least one ceramic base body (40a, 42a; 40b, 42b; 40c, 42c; 40d, 42d) at least partially forms the sealing tool (34a; 34b; 34c; 34d) with the sealing zone for a direct contact with the container (12a).

7. The sealing device according to claim 1, wherein the sealing tool (34e) is configured as an attachment, which is, in particular reversibly, arranged at the ceramic base body (40e, 42e).

8. The sealing device according to claim 1, further comprising a centering unit (56d) for securing the container during a sealing process, and comprises a sealing holder (58d) for an accommodation of the at least one ceramic heating unit (36d), the at least one ceramic heating unit (36d) being arranged in a form-fitting manner between the centering unit (56d) and the sealing holder (58d).

9. The sealing device according to claim 1, further comprising a sealing holder (58f) for accommodating the at least one ceramic heating unit (36f), wherein the sealing holder (58f) forms the sealing tool (34f) with the sealing zone.

10. The sealing device according to claim 1, wherein the at least one ceramic base body (40a, 42a; 40b, 42b; 40c, 42c; 40d, 42d; 40e, 42e; 40f, 42f; 40g, 42g; 40h; 40i, 46i) is made of silicon nitride or aluminum nitride.

11. A sealing station with at least one sealing carrier (28a) for supporting at least one sealing device, with at least one sealing device according to claim 1, and with at least one sealing support (30a) for supporting the container (12a) during sealing.

12. A method for producing a sealing device according to claim 1.

13. The method according to claim 12, wherein in at least one method step, in a hardened state of the ceramic base body (40a, 42a; 40b, 42b; 40c, 42c; 40d, 42d; 40e, 42e; 40f, 42f; 40g, 42g; 40h; 40i, 46i), the ceramic base body (40a, 42a; 40b, 42b; 40c, 42c; 40d, 42d; 40e, 42e; 40f, 42f; 40g, 42g; 40h; 40i, 46i) is adapted to a designated container geometry by material removal.

14. The method according to claim 12, wherein in at least one method step, in which the ceramic base body (40a, 42a; 40b, 42b; 40c, 42c; 40d, 42d; 40e, 42e; 40f, 42f; 40g, 42g; 40h; 40i, 46i) is present in a hardened state of the ceramic base body (40a, 42a; 40b, 42b; 40c, 42c; 40d, 42d; 40e, 42e; 40f, 42f; 40g, 42g; 40h; 40i, 46i), a temperature sensor (18a, 20a; 18b, 20b; 18c, 20c; 18d, 20d; 18e, 20e; 18f, 20f; 18g, 20g; 18h; 18i, 20i) is inserted into a sensor material recess of the hardened ceramic base body (40a, 42a; 40b, 42b; 40c, 42c; 40d, 42d; 40e, 42e; 40f, 42f; 40g, 42g; 40h; 40i, 46i).

15. The method according to claim 13, wherein in at least one method step, in which the ceramic base body (40a, 42a; 40b, 42b; 40c, 42c; 40d, 42d; 40e, 42e; 40f, 42f; 40g, 42g; 40h; 40i, 46i) is present in a hardened state of the ceramic base body (40a, 42a; 40b, 42b; 40c, 42c; 40d, 42d; 40e, 42e; 40f, 42f; 40g, 42g; 40h; 40i, 46i), a temperature sensor (18a, 20a; 18b, 20b; 18c, 20c; 18d, 20d; 18e, 20e; 18f, 20f; 18g, 20g; 18h; 18i, 20i) is inserted into a sensor material recess of the hardened ceramic base body (40a, 42a; 40b, 42b; 40c, 42c; 40d, 42d; 40e, 42e; 40f, 42f; 40g, 42g; 40h; 40i, 46i).

16. The sealing device according to claim 2, wherein the at least one ceramic heating unit (36i) comprises at least one additional ceramic base body (46i), which is realized separately from the ceramic base body (40i), wherein the ceramic base body (40i) and the additional ceramic base body (46i) are arranged on different closed paths around a geometric center (48i) of the at least one ceramic heating unit (36i).

17. The sealing device according to claim 3, further comprising a control or regulation unit (50a; 50e) for a separate controlling or regulation of a temperature of the ceramic base bodies (40a, 42a; 40b, 42b; 40c, 42c; 40d, 42d; 40e, 42e; 40f, 42f; 40g, 42g; 40h; 40i, 46i).
